(19) United States
(12) Patent Application Publication
(10) Pub. No.: US 2017/0070404 A1
(43) Pub. Date: Mar. 9, 2017

(54) System Method and Apparatus for Managing Applications and Services

(71) Applicant: KEERTIKIRAN GOKUL, SECUNDERABAD (IN)

(72) Inventor: KEERTIKIRAN GOKUL, SECUNDERABAD (IN)

(21) Appl. No.: 15/356,556

(22) Filed: Nov. 19, 2016

Related U.S. Application Data
(63) Continuation of application No. 14/206,466, filed on Mar. 12, 2014.
(60) Provisional application No. 61/779,657, filed on Mar. 13, 2013.

(51) Int. Cl. H04L 12/24; H04L 29/08

(52) U.S. Cl. CPC H04L 41/5096; H04L 67/16; H04L 41/5029; H04L 67/325; H04L 67/34

(57) ABSTRACT

The disclosure provides a system, methods and a computer program product that facilitate management, distribution, licensing and provisioning of services. The disclosure includes a repository of one or more services wherein the repository can be populated or managed by one or more entities, organizations or individuals. The disclosure also includes a step of associating one or more services with context matching criteria, wherein the criteria can be matched against contextual information associated with environment/activity of a service consumption device and/or end user associated with the service consumption device. The disclosure also includes a step of delivering and/or enabling a subset of services from the repository on a service consumption device when contextual information of the service consumption device or an end user of the service consumption device matches the context matching criteria associated with the subset of services.

### CROSS-REFERENCE TO RELATED APPLICATIONS

This application uses the frammis vane disclosed in patent application Ser. No. 13/193,380, filed 28 Jul. 2011, by the present inventor, which is incorporated here by reference.

The present application claims the benefit of U.S. (Provisional) Application No. 61/779,657, filed Mar. 13, 2013, the contents of which are incorporated herein by reference in their entirety.

This is a continuation of application Ser. No. 14/206,466, filed Mar. 12, 2014, which is a non-provisional of U.S. Provisional Application No. 61/779,657, filed Mar. 13, 2013, each of which is herein incorporated by reference in its entirety.

### FEDERALLY SPONSORED RESEARCH

None

### SEQUENCE LISTING

None

### BACKGROUND

The present invention relates management of applications and/or services, and in particular to systems, methods and apparatus for discovery, management, provisioning and sharing of applications and services.

With advent of portable computing such as smart phones, tablet computers, wearable PCs, e-book readers, personal digital assistants (PDAs), etc. users of these devices have access to a large number of applications (apps for short), with each application used for one or more tasks. These devices are referred to herein as service consumption devices (SCD). The Android™ platform of Google, Inc., and supported by Open Handset Alliance (OHA), for example supports thousands of applications in different areas that include health, lifestyle, entertainment, games, shopping, social, tools, productivity, etc. among others. The applications for Android platform are generally made available to service consumption devices on Android Market of Google, Inc. Similarly, the App Store™ of Apple, Inc., provides thousands of applications in various areas of interest, which can be run on devices such as iPhone™, iPad™, iPod Touch™, etc. of Apple, Inc. Mobile applications can also distributed using other store-fronts such as Amazon AppStore of Amazon Inc., GetJar, Samsung Apps from Samsung Group or the like.

To help users choose applications for installation and use on their devices, Android Market, App Store, other distribution platforms/systems and websites classify applications into various categories such as social, productivity, tools, finance, etc. In some cases, the applications are sorted based on factors such as popularity, user reviews, staff reviews, featured applications or the like. Mobile Application Platforms described earlier, allow users of SCDs to search for and install applications. SCDs can provide services to end users using applications installed on SCDs. In some cases, as in case of Android Market, users of SCDs can choose to have installed apps update to new versions automatically, as and when the new versions become available. This method of distribution does not allow for discovery or providing new applications and/or services.

Entities such as businesses may need to provide services to end users who have not installed applications associated with entities, or when entities do not have mobile applications, and existing distribution models do not address this problem.

Services provided can be transient in nature, as when a person visits a store for example. Existing distribution systems require end user to search and install app associated with the store, to consume their services, which can be a cumbersome task as user keeps visiting a number of stores. Existing distribution systems are geared towards apps that are installed and used for longer periods of time, and are not oriented towards easy discovery and availability of transient applications and/or services—which may be used only for few seconds or few minutes. Existing distribution systems are also not geared towards a model of providing a large number of services and/or applications in a short period of time.

Existing application distribution systems (ADS) allow for entities, referred to as app developers (AD) from now on, to provide applications to their distribution systems. Applications (or apps for short) from AD are distributed by ADS. Existing ADS provide very limited or no control to AD, on how and when the apps provided by them are discovered by or made available to end users.

Existing ADS do not allow apps provided by AD to be shared with entities such as businesses to allow them to be used by their customers. Businesses can exist on ADS only by providing an app to ADS, similar to an AD. Similarly, existing ADS do not allow for ADs to share each other apps, as part of providing some functionality to a user. For example an AD ‘M’ may want to use a video-player app developed by another AD ‘N’ to show the video that is delivered by AD ‘M’.

Existing ADS do not allow for a group of related apps to be purchased or distributed together. Allowing for purchase or distribution of group of apps can allow AD to increase visibility of their apps by having their app be distributed along with other apps that are high in demand. Allowing for sale or distribution of group of apps can also allow for AD to increase the sales or distribution of apps by promoting sale of groups of apps, or for user to explore new apps or services.

Existing ADS do not allow for distribution of applications or services that are valid or usable for a limited period of time. Allowing for such limited-use services or applications can allow AD to increase the distribution or visibility of their apps by providing different pricing structures, or other marketing strategies. Allowing for limited time-based apps can also allow for businesses to offer some services or applications for a limited time, as part of another business transaction. Such models can also help support or drive or enhance business transactions that may not be tied to ADS or apps. For example, a travel agent may offer some high-end travel planner for a limited duration when someone purchases tickets from them. Existing ADS do not allow any such model or method of application distribution.

Existing ADS allow for either giving away applications for free, or for sale. In either case, the apps can be downloaded to an SCD and the downloader/purchaser gets to use the app as long as they want. Also, existing ADS do not allow for continuous revenue generation models. Allowing for continuous revenue generation can make ADs get ongoing revenue from, or continuous exposure of apps or services they develop. In an embodiment of present invention, allowing entities such as businesses, to license apps developed by ADs can allow for continuous revenue generation for ADs. In such embodiment, licensing terms that can include the amount charged to businesses on basis such as time (monthly for example) the app is used, the number of customers (associated with business) that actually used the app, or the like.

Apps fetched from existing ADS are not provided with any contextual information. In order to support different behavior based on contextual information (that cannot be derived from sensors on the SCD), the app may need to have its own service, say on the network such as internet, that provides such information. If the app does not have its own service, it may need to access some other third party services. For example, an app may access a location based service over a network such as internet, to determine the stores in the vicinity of the SCD. Setting up such services can be expensive, or the information provided by third party services can be generic in nature.

It would therefore be desirable to provide improved systems that facilitate provisioning, sharing, management, distribution and discovery of applications and services.

### SUMMARY

In accordance with some embodiments of the present invention, a service consumption device (SCD) of an end user (EU), communicatively coupled to a service distribution/management system (SMS) can be used to discover and distribute applications. Discovery and distribution of applications and services can be related to contextual information associated with SCD and/or end user. The contextual information referred to herein as a “tag” can encompass any type of data that facilitates determination of one or more applications (apps). The contents of tag, or tag related information (TRI) and the method of determining them are specific to each embodiment.

In one embodiment, a tag can include a URL. In some embodiments, the URL included in a tag can be used identify a location on internet where the application can be downloaded from.

In other embodiments, the tag can include a tag-type. Tag type can be a value from a set that can include values such as GroceryInfo, ClothesInfo, WebForm, ParkingLot, Video, Audio, DerivedMedialnfo, SampledMedia, TvLiveVoting, SaleSchedule, Feedback, UserOrderinStore, or the like. In some embodiments, the tag type can be used to determine an application and/or a URL. The URL in such embodiments can identify an application or a location on internet where the application can be downloaded from.

In some embodiments, a tag can include information that can be used by the application determined using or associated with the tag. A TvLiveVoting tag, for example, can be associated with a Voting application. The Voting application in one embodiment can interact with a user to determine the user's vote. The TvLiveVoting tag in such embodiments can include a URL where the results determined by Voting application can be submitted.

In some embodiments of present invention, patent application with Ser. No. 13/193,380 describes systems, methods and apparatus of managing apps on SCDs based on tags and/or contextual information.

Another aspect of an embodiment of the present invention relates to end users (EU). An EU can use SCD to consume services made available using SCD.

Another aspect of an embodiment of the present invention relates to app developers (AD). AD can be any entity or individual that can determine and/or develop SVC. An AD can provide SVC to SMS for distribution, management, delivery, or the like.

Another aspect of an embodiment of the present invention relates to business entities (BEs). BE can be any entity, store, or individual that make services available to EU using SMS. BE can use SVCs provided by AD to SMS, or provide new SVCs to SMS for making them available to EUs/SCDs.

In other embodiments of present invention a given entity or individual can be associated with one or more aspects of EU, AD and BE.

Another aspect of an embodiment of the present invention is the system of managing and distributing applications and/or services, referred to as service distribution/management system (SMS). In one embodiment of the present system, a SMS can be built using, among other software and/or hardware components, a multi vendor e-commerce shopping cart system. Multi vendor shopping cart systems can be built using systems such as Magento e-commerce web application from Magento Inc., KonaKart eCommerce system from DS Data Systems UK Ltd, or the like. Multi-vendor shopping cart systems allow multiple vendors to upload and sell their products, alongside other vendors, on one e-commerce website. In one embodiment of the invention, App developers (AD) in SMS can be represented using vendors in a multi-vendor system, End users (EUs) can be represented as customers of the ecommerce systems, and business entities (BEs) can be represented as vendors. Other ways that can include custom methods, of building SMS are also possible. In some embodiments of the system, SMS can also include features/services not described herein.

An aspect of an embodiment of the present invention relates to a service (SVC). In one embodiment of the present invention, an SVC can include a mobile application that is downloaded by end users on Android Market. In another embodiment of present invention, SVC can include a URL that is consumed by an application such as a browser to provide service to end user. An SVC can therefore be any piece of information, or software that can help in identifying and/or determining the service and/or application provided to end user.

An aspect of an embodiment of present invention relates to a service entry (SE). An SE identifies an SVC and related information in an SMS. A SE can include among other information, one or more of, information identifying service (SVCID), Mobile Application (APP), information to be provided to SVC, context relevancy info (SECRI), and Licensing Information (LI). SVCID can refer to a URL which can be consumed by another application such as a browser to provide service(s). SVCID can also refer to other services. APP can refer to a mobile application that can be downloaded to SCD and invoked, for providing services. SECRI can be used to provide information about contexts in which the service is relevant. In one embodiment SECRI can include a location, such that the application is declared relevant when a user visits the location. In another embodiment SECRI can include a phone number, such that the application is declared relevant when user dials the phone number. Other embodiments can choose to include information not described here. SECRI can be provided by app developer or determined by SMS. In some embodiments of present invention, SE can include LI. LI can be provided by AD to determine the terms agreed upon by BE in order to use SVC provided by AD, to provide services. In some embodiments of the present invention BE can be required to pay a monthly or fixed fee to AD, in order to use the SVC provided by the AD, to provide services.

An aspect of an embodiment of present invention relates to a service order (SO). SO can include one or more of service order entry (SOE)s. Among other information, SOE can include identification of an SVC in SMS, customization information such as icons, names, or the like, information to be provided to SVC (PARAMS), and licensing terms. In one embodiment of the present invention, where an ecommerce system is used as a component of SMS, BE can create a SO in SMS by browsing for SVCs, and adding SVCs to shopping cart selectively. When adding SVC to shopping cart, the BE agrees to licensing terms provided by AD, provides any information that SVCs need including any custom icons, names, or the like, provides contextual relevancy information (SOCRI) and places the order. SOCRI can be used to provide contextual information where the SO must be made available. In some embodiments of present invention, SOCRI can include one or more of a mailing address, a location, WiFi hotspot information, a phone number, a URL, an email address, or the like. Other embodiments can use different contextual information, not described here, to determine relevancy.

Another aspect of an embodiment of the present invention relates to provide time-based applications or services. In one embodiment of the invention described here, ADs can create a group of applications or services that end users can purchase together as a single entity. The group of applications can be purchased for indefinite use, or for limited period.

An aspect of an embodiment of present invention relates to sharing of applications or services. An application or service (SVC) provided by AD to SMS can be shared with business entities (BEs). The sharing can be associated with BE paying certain licensing fees (or other benefits) to AD associated with SVC. BEs can use the SVCs licensed by them in SMS, to provide services to their customers—such as when customers visit store associated with BE. Other models of sharing are possible.

Another aspect of an embodiment of the present invention relates to the controls available to AD in determining the context in which the SVC (associated with AD) is made available automatically for use by EUs (without EUs having to search for them and install them). AD when providing an SVC to SMS, provides contextual relevancy information (SECRI) under which AD becomes relevant. SMS can use the information described by SECRI to determine when the SVC becomes relevant, and make the SVC available on SCDs where the contextual information indicates relevancy when compared to SECRI. Other methods/controls can be provided to AD to help determine the relevancy and/or delivery of their SVCs, in other embodiments.

Another aspect of an embodiment of the present invention relates to making SVCs available automatically, for use by EUs on SCD. In an embodiment, the SCD monitors contextual information associated with sensors on the device, applications/services on SCD, environment of SCD (such as location, wifi, etc.) or the like. Such information can be relayed by SCD to SMS, which then delivers SVCs relevant for contextual information, to SCD, for use by EU. In some embodiments, such SVCs may be made unavailable when the contextual information does not indicate relevancy. Other methods of determining relevant applications, and making them available or unavailable are possible in other embodiments.

Another aspect of an embodiment of the present invention relates to the method of making applications available. In one embodiment, availability of an application can be indicated to the EU of SCD, by displaying an icon and text on the display of SCD. When EU initiates the launch of application, say by clicking the displayed icon, one can fetch associated application and launch it. The fetched application can include one or more of web-services, web content, java script, java byte code, CPU executable code, or the like. The fetched application can also include applications that can be installed by user on the SDC, a modified version of such installable applications, or the like. The application can be executed or run by the CPU, or by means of other software. Application can include any combination of software and/or firmware and/or hardware that can provide some services to SCD and/or EU.

The following detailed description together with accompanying drawings will provide a better understanding of the nature and advantages of aspects of various embodiments associated with the present invention.

### BRIEF DESCRIPTION OF THE DRAWINGS

FIG. 1 illustrates a Service Consumption Device (SCD) for consumption of services according to an embodiment of the present invention.

FIG. 2 illustrates a Service Management/Distribution System (SMS) for managing, distribution and discovery of services according to an embodiment of the present invention.

FIG. 3 illustrates a list of types of services (SVC) according to an embodiment of the present invention.

FIG. 4 illustrates a set of information that can be associated with a service (SVC) in an SMS according to an embodiment of the present invention.

FIG. 5 illustrates a set of information that can be associated with a service in preparation for adding to an SO according to an embodiment of the present invention,

FIG. 6 illustrates the set of information associated with a service order (SO) according to an embodiment of the present invention.

FIG. 7 illustrates the method to be followed in creating an SE in SMS according to an embodiment of the present invention.

FIG. 8 illustrates the method to be followed in removing an SE from SMS according to an embodiment of the present invention.

FIG. 9 illustrates the method to be followed in creating an SO in SMS according to an embodiment of the present invention.

FIG. 10 illustrates the method to be followed in removing an SO from SMS according to an embodiment of the present invention.

FIG. 11 illustrates a method of discovering and delivering services, according to an embodiment of the present invention.

FIG. 12 illustrates a system of creating services, managing and delivering them according to an embodiment of the present invention.

FIG. 13 illustrates a method of creating a group service entry, representing a set of applications or services, according to an embodiment of the present invention.

FIG. 14 illustrates a method of removing a group service entry, representing a set of applications or services, according to an embodiment of the present invention.

FIG. 15 illustrates a method of accessing group service entries on an SCD, according to an embodiment of the present invention.

FIG. 16A-B illustrates a list of types, one of which can be associated with a tag according to an embodiment of the present invention.

### DETAILED DESCRIPTION

### First Embodiment

### Structure of First Embodiment

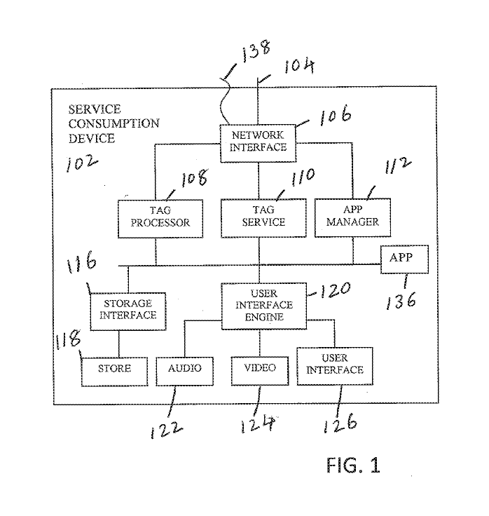

FIG. 1 illustrates a Service Consumption Device (SCD) 102 for managing applications according to an embodiment of the present invention. In this embodiment SCD 102 can include tag processor (TAGP) 108, Tag service (TAGS) 110, application manager (AMAN) 112, application (APP) 136, storage interface (STI) 116, storage (STORE) 118, user interface engine (UIE) 120, audio output device 122, video output device 124, user interface 126, network interface 106, antenna 104 and network cable 138. In one embodiment, audio device 122 can include, e.g., a conventional headphones jack and/or one or more speakers. Video Output 124 can include, e.g., an LCD screen. User Interface 126 can include, e.g., one or more buttons, touch pads, touch screens, scroll wheels, click wheels, or any other control(s) capable of generating electrical signals corresponding to manipulations of the control(s) by a user. Embodiments of SCD 102 can be associated with portable media devices (PMD), personal digital assistants (PDA), media servers, devices such as mobile phones, PCs, server computers, laptops, set top boxes such as those associated with television sets, or the like. An instance of SCD 102 can be static and not moving physically like a desktop computer, or can be a mobile device—such as a laptop or a mobile phone. In some embodiments, instances of SCD 102 can be connected to other entities of the system by a variety of network technologies that can include wired and/or wireless communications, such as ethernet, USB, modems, cable modems, firewire, wifi, cellular communication networks, or the like. In some embodiments, SCD 102 can be an instance of CD as described and operating as in patent application Ser. No. 13/193,380.

User Interface Engine 120 can include any combination of circuitry and/or software that enables a user to control operation of SCD 102. In one embodiment, user interface engine 120 receives user inputs from user interface 126 and provides commands to AMAN 112 and/or TAGS 110 and/or APP 136. User interface engine 120 can also receive data from AMAN 112 and/or TAGS 110 and/or APP 136, and provide output to user via audio output device 122 and/or video output device 124.

APP 136 can include any combination of firmware and/or software and/or circuitry that can allow the SCD 102 in providing one or more services to a user of SCD 102. An instance of SCD 102 can be associated with one or more instances of APP 136. In one embodiment, APP 136 can interact with user using audio device 122, video output device 124 and/or user interface 126, with help from user interface engine 120. In one embodiment APP 136 can allow the user to purchase a product. Other examples of APP 136 can allow the user to make stock transactions online, search for an item among a set maintained by a server, update personal information associated with a user at a server, providing a rating/vote related to participants in a live reality TV show, get information related to items in an aisle of a grocery store, provide information regarding availability of spaces in a parking lot, record the schedule related to a sale that is currently advertised on a TV, get information related to items purchased at a store, mall or online; provide feedback related to a service/purchase received/made by the user, among others. APP 136 can be associated with graphical interfaces in some embodiments.

In some embodiments, some or all aspects of APP 136 can be retrieved by AMAN 112 from a network using NI 106. In some embodiments, some or all aspects of APP 136 can be stored in STORE 118. An instance of APP 136 can be made available for providing services to users of SCD 102 by AMAN 112. AMAN 112 can retrieve an APP 136 from network using NI 106 or from STORE 118 before making the APP 136 provide services to user of SCD 102. Examples of APP 136 can include Applications (that can include Activity, Service, etc.) associated with Android Operating System, Applications associated with iOS such as the one related to the operating system running on iPhone, iPad, iPod Touch, or the like; or applications associated with other operating systems, platforms, or the like. In one embodiment, Applications related to Android Operating system can be associated with APP 136. In this example embodiment, android application can be downloaded from network by AMAN 112 using NI 106 or stored in STORE 118. An application can be made active (or made to run) by AMAN 112 by retrieving the application from STORE 118, retrieving the application from NI 106, or the like. In some embodiments, one or more instances of APP 136 can be dormant and/or not providing services to user of SCD 102. In such embodiments, APP 136 can be made active or provide services to user of SCD 102, by AMAN 112 using mechanisms that can be specific to the embodiment (such as using Intents on Android Operating System).

In some embodiments, there can be more than one instance of APP 136 running on SCD 102, each providing a different service to the user. APP 136 can use NI 106 in communicating with devices or services in the network. In some embodiments, APP 136 does not interact with a user. An instance of APP 136 in such embodiments can be providing services to another application associated with SCD 102. Instances of APP 136 can be providing services to more than one application associated with SCD 102.

Network interface 106 can include any combination of circuitry and/or software that can allow SCD 102 and/or aspects of SCD 102 in communicating with other devices in a network. Network interface 106 can include software components such as TCP sockets, UDP sockets, etc. Network interface 106 can also include hardware components such as NICs, Network interface 106 can also include a connector (not shown) providing mechanical and/or electrical coupling to connect to antenna 104 capable of sending/receiving messages over a network. Network interface 106 can also include a connector (not shown) providing mechanical and/or electrical coupling to cable 138 capable of receiving/sending messages over a network. The network can include wired communication medium such as ethernet, firewire, cable modem interface, USB or the like. The network can also include wireless medium such as Bluetooth, WiFi, cellular communication network or the like. The network over which the messages are sent can include internet, local area network, wide area network, cellular communication network, 3G communications, or the like. Network interface 106 can be connected to antenna 104 and/or cable 138 with or without a connector.

Storage 118 can be used to store information that can include one or more of APP 136 retrieved from network, media assets (e.g., music, video, podcasts, photos, or other still images, etc.) as well as tags provided by PDs. Storage device 118 can include, e.g., magnetic or optical disk, flash memory, or any other storage medium that supports storage of data for an arbitrary period of time (e.g., until deleted by a user). Storage Interface 116 can include any combination of circuitry and/or software that manages access to storage 118. In one embodiment, SI 116 supports reading from and writing to STORE 118.

TAGP 108 can include any combination of circuitry and/or software that can allow SCD 102, to determine and process tags. In one embodiment of the invention, TAGP 108 can determine tags such in communication with a Tag service TAGS 110, on SCD 102. TAGP 108 can determine if the received tag can be used by the SCD 102. TAGP 108 can also communicate received tags to AMAN 112.

TAGS 110 can include any combination of circuitry and/or software that can allow SCD 102, to determine tags. In an embodiment of the present invention, TAGS 110 can determine tags by communicating with services on the device such as a phone dialer service. In another embodiment of the present invention, TAGS 110 can determine tag such as a location by communicating with a location sensor such as GPS sensor on the device. In yet another embodiments of the invention, TAGS 110 can determine tags by communicating with external devices and/or services by communicating with them using NI 106, or any other connectivity or communication mechanisms.

AMAN 112 can include any combination of circuitry and/or software that can allow SCD 102, in managing one or more instances of APP 136. In one embodiment of the invention, AMAN 112 can manage more than one instance of APP 136. AMAN 112 can receive tags from TAGP 108. AMAN 112 can associate tags to instances of APP 136 that are active and providing services to users of SCD 102, or can associate tags to instances of APP 136 that can be retrieved from network or STORE 118. When tags can be associated with instances of APP 136 from network or STORE 118, AMAN 112 can retrieve APP 136 from network or STORE 118. The retrieved APP 136 can be activated, which can result in APP 136 starting to provide services.

In embodiments wherein some/all aspects of SCD 102 can be included in devices such as smart phone supporting Android operating system, AMAN 112 can be implemented using an application on Android operating system. AMAN 112 in such embodiment can be associated with one or more aspects of Android operating system such as Activity, Service, Intents, including any others.

Instances of APP 136 retrieved from network by AMAN 112 can be stored in STORE 118 in a way that the instances of APP 136 stored by AMAN 112 can be differentiated from instances of APP 136 that are not stored by AMAN 112. In the example embodiment of smart phone running Android operating system, a user of SCD 102 can choose to download applications by browsing the applications provided by Android Market. The set of applications download by the user using Android Market, in such embodiments can be maintained separately from the applications downloaded and stored in STORE 118 by AMAN 112. The set of APP 136 instances stored in STORE 118 due to methods that can not involve AMAN 112 is referred to as manualAppStore for use in apparatus, methods and systems of the invention and related embodiments. The set of APP 136 instances stored in STORE 118 by AMAN 112 is referred to as appStore for use in apparatus, methods and systems of the invention and related embodiments. In some embodiments where a file system can be available to manage STORE 118, appStore and manualAppStore can be implemented using different directories in the file system. Examples of file systems include FAT-16, JFFS, EXT2, or the like, supported by various operating systems that can include Windows from Microsoft Corporation, Linux, Android, or the like.

Aspects of NI 106, TAGP 108, TAGS 110, AMAN 112, APP 136, STATE 114, STI 116, STORE 118, UIE 120, audio device 122, video device 124, UI 126 can be implemented e.g., using software executing on one or more suitably configured microprocessors or microcontrollers (not explicitly shown). Other implementations are also possible.

SCD 102 can also include other aspects in addition to or instead of those shown here. For example, SCD 102 can include a camera that an allow SCD 102 to be used in taking still/motion pictures. Camera on SCD 102 can be associated with some of instances of APP 136 that can provide services to users of SCD 102. SCD 102 can also not include some of the aspects described herein.

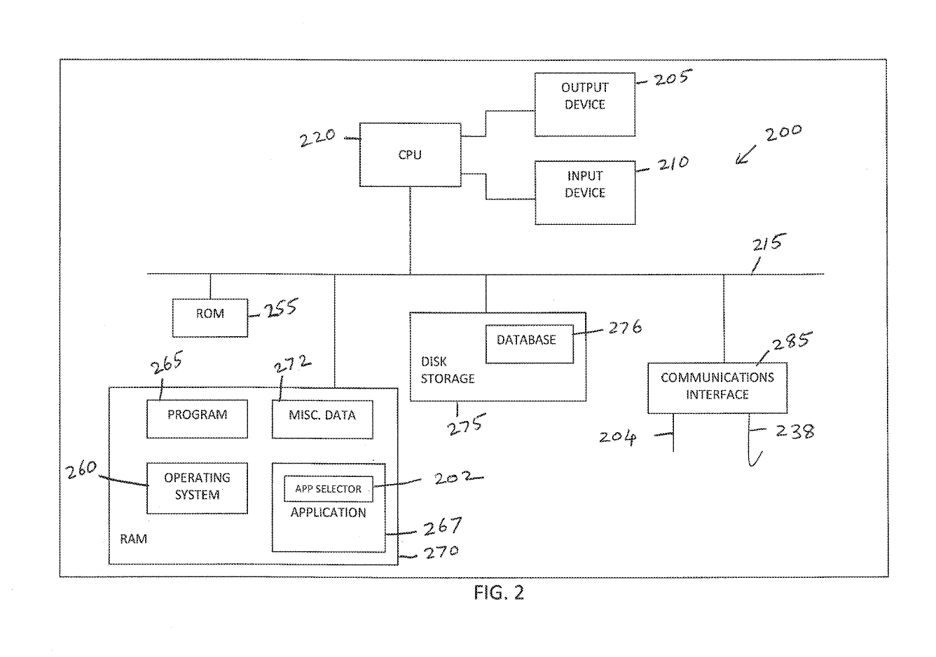

FIG. 2 illustrates a block diagram of a service management system (SMS) 200 for management, discovery, sharing and distribution of applications and/or services, according to an embodiment of the present invention. SMS 200 can include a CPU 220, an input device 210, such as a keyboard and mouse, and an output device 205, such as a CRT or voice module, coupled to CPU 220. ROM 255, RAM 270, communications interface 285 and disk storage 275 are coupled to CPU 220 via signal bus 215.

Operating system 260 is software that controls and facilitates the processing carried out by CPU 220, and is typically stored in RAM 270. Application 267 is a program, such as a word-processor or e-mail program, that presents data on output device 205 to a user. In an embodiment of the present invention, Application 267 can include a web server such as Apache as described at http://httpd.apache.org/. Application 267 can also include ecommerce systems and/or their extensions/modifications to allow for methods described herein. Application 267 can also include app-selector APPSELECTOR 202 functionality that allows determining applications associated with a certain tag. In some embodiments web-services in communication with one or more databases can help in providing such functionality. Parts/whole of Program 265 and application 267 of an embodiment of the present invention can be loaded for operation, by operating system 260, in RAM 270. This program 265 and application 267 may be stored in disk storage 275 and loaded into an allocated section of RAM 270 prior to execution by CPU 220. Another section of RAM 270 is used for storing intermediate results and miscellaneous data 272.

Disk storage 275 can also include one or more databases DATABASES 276 that may be used by Application 267 and/or APPSELECTOR 202. In some embodiments of present invention, mySql software can be used to support aspects of DATABASES. mySql can be downloaded from http://www.mysql.com/.

Communications interface 285 can include any combination of circuitry and/or software that can allow SMS 200 and/or aspects of SMS 200, Application 267 in communicating with other devices in a network. Communications interface 285 can include software components such as TCP sockets, UDP sockets, etc. Communications interface 285 can also include hardware components such as NICs, Communications interface 285 can also include a connector (not shown) providing mechanical and/or electrical coupling to connect to antenna 204 capable of sending/receiving messages over a network. Communications interface 285 can also include a connector (not shown) providing mechanical and/or electrical coupling to cable 238 capable of receiving/sending messages over a network. The network can include wired communication medium such as ethernet, firewire, cable modem interface, USB or the like. The network can also include wireless medium such as Bluetooth, WiFi, cellular communication network or the like. The network over which the messages are sent can include internet, local area network, wide area network, cellular communication network, 3G communications, or the like. Communications interface 285 can be connected to antenna 204 and/or cable 238 with or without a connector.

### Content of Information

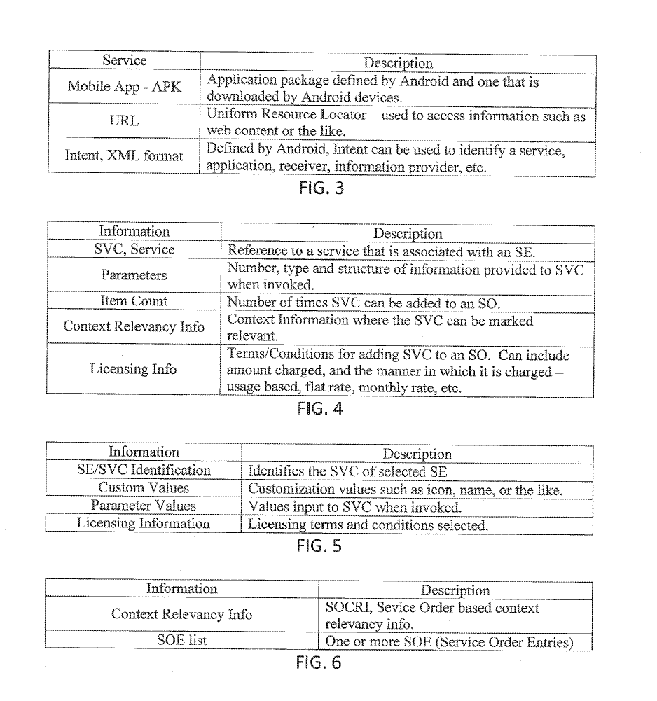

FIG. 3 illustrates a list of type of services (SVC) according to different embodiments of the present invention. In one embodiment of a present invention, SVC can refer to a mobile application such as an APK file retrieved from Android Market or Amazon App Store for Android. In yet another embodiment of present invention, SVC can refer to a URL that identifies the service. A URL can be provided to a browser to fetch and provide services associated with URL. In another embodiment of the present invention, SVC can provide information such as a part/entirety XML document that can be processed on SCD 102 to determine the SVC. When SCD 102 runs Android, an XML document describing an Intent (as defined by Android) can be used to determine a service or application. Other application platforms may have different methods of determining an application or service, not described herein.

FIG. 4 illustrates information that can be associated with a service entry (SE) in an SMS according to an embodiment of the present invention. In an embodiment where ecommerce systems are extended to support SMS, a SE can represent a product and associated information in the ecommerce system. An SE can include references to SVC, and list of parameters to the SVC can be stored as attributes of the product in the ecommerce system. Parameters describe the number, type, structure of values that can be provided as input the SVC when it is invoked or executed or run by SCD. A product in an ecommerce system can also be associated with an item-count that represents the number of instances or items of that product that can be ordered. Such count can be used in SMS to limit the number of times the SVC can be ordered by BEs. In some other embodiments, such a count is not used. A SE can also be associated with Context Relevancy Info (SECRI) that identifies the contexts in which aspects of SE such as SVC can be made relevant. In some embodiments, context information can include a phone number such that when someone dials the phone number associated with an SVC on an SCD, the SVC can be made relevant and delivered to the SCD. Other embodiments can choose to include information not described here, or exclude information described here, to be provided by AD, and which can be used to determine relevancy of SVC. The relevant app can also be invoked on SCD. A SE can be associated with licensing information, that can include information about the terms under which SE can be included in SOs. In one embodiment, the licensing terms can specify the amount of money that needs to be paid to AD when the SVC is used in an SO. The terms can include one-time charge, monthly charge, usage-based charge, or the like. Other licensing terms/conditions are also possible. The licensing terms may also include association with features and/or systems not described in the embodiment and/or embodiments of the current invention. The model of AD providing relevancy information provides AD with tools to indicate relevancy, and hence distribution/delivery of SVC associated with AD.

FIG. 5 illustrates information associated with a service order entry (SOE) according to an embodiment of the present invention. In an embodiment where a shopping-cart based ecommerce system is used as an aspect/component of SMS, a SOE can be represented using an item in shopping cart. When a request is placed to add an SVC to the shopping cart, information such as Custom SVC name, custom icon image, values for parameters to be provided to SVC, and licensing information can be provided. If a BE requests that an SVC be added to the shopping cart, the BE can be required to provide all such information before the SVC is added to the cart. One can choose to add one or more SOEs to a shopping cart. One can think of this as similar to (but not same as) adding items in an online ecommerce shopping/apparel store, where the buyer can specify a color, size, material, etc. when a clothing piece is added to a shopping cart. Custom SVC name and custom icon image can be used to present the SVC to end user when the SVC is delivered to SCD. Parameter values can also be delivered to SCD along with SVC, to be provided to SVC when the SVC is invoked or executed or run on SCD. One can envision a SVC that behaves differently either in subtle or major ways based on values that are provided to it at the time of invocation or execution. To someone familiar with programming languages, these parameters can be thought of as arguments to a program when it is invoked. Licensing information provided/selected by a BE can be used to determine the terms and conditions under which the SVC is granted to BE for the purpose of SOE/SO. In some situations, the terms can include BE paying money to AD that provided the SVC. The money can be a fixed amount, or a fixed amount paid regularly on a monthly basis, or an amount paid regularly based on other parameters such as actual usage of SVC, or the like. In some embodiments, a portion of such payment can be made to SMS for providing the service. These methods can allow for ADs to gain more revenue by licensing SVC to BEs. BEs can also provide services to their customers, without having to develop an application or service. BEs can also have the option of choosing SVCs provided by a large number of ADs, allowing for increased choice. Other embodiments can include other information in SOE, not described herein.

FIG. 6 illustrates a service order (SO) that can be associated with an embodiment of the present invention. In an embodiment where a shopping-cart based ecommerce system is used as an aspect/component of SMS, a SO can be represented using an order. An SO can include one or more SOEs. When an order is placed, content relevant information (SOCRI) can be associated with the order. In some embodiments, SOCRI can include a phone number. In those embodiments, when someone dials a phone number on an SCD, matching the phone numbers in SOCRI of one or more SOs in SMS, apps in matching SOs can be delivered and made available on the SCD. Other embodiments can choose to include information not described here, or exclude some information described here. SOCRI can include a combination of a location, wifi access information, a URL, an email, a social tag, or the like. The type, structure and set of values included in SOCRI described here are not meant to limit the scope of the invention or it's embodiments in any way. This method can allow for BEs to deliver targeted services to their customers. The services provided to customers can be different in different contexts such as locations, phone numbers, or the like. Other embodiments can choose to include other information, or exclude information described here.

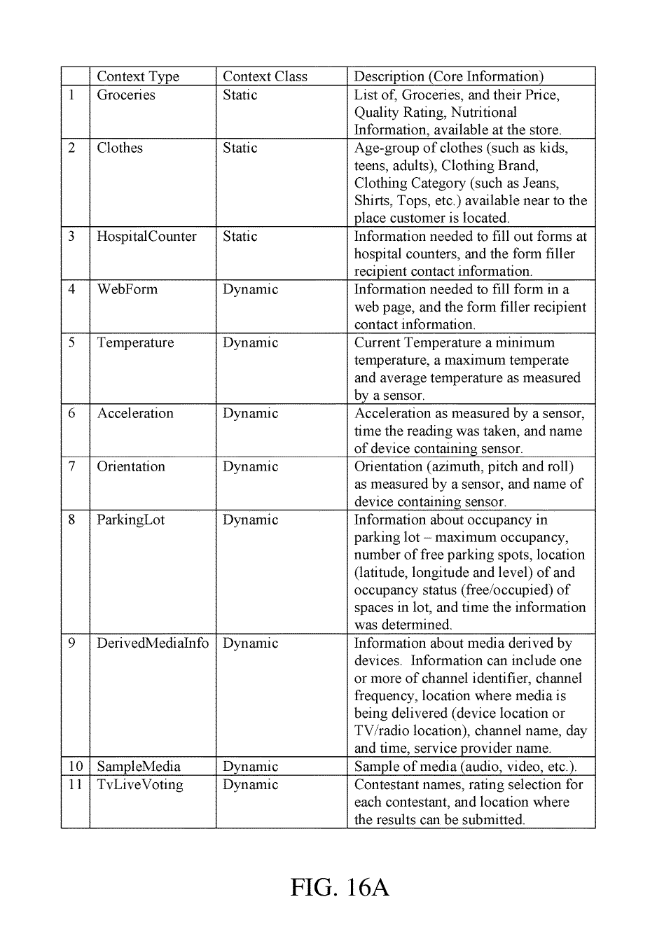

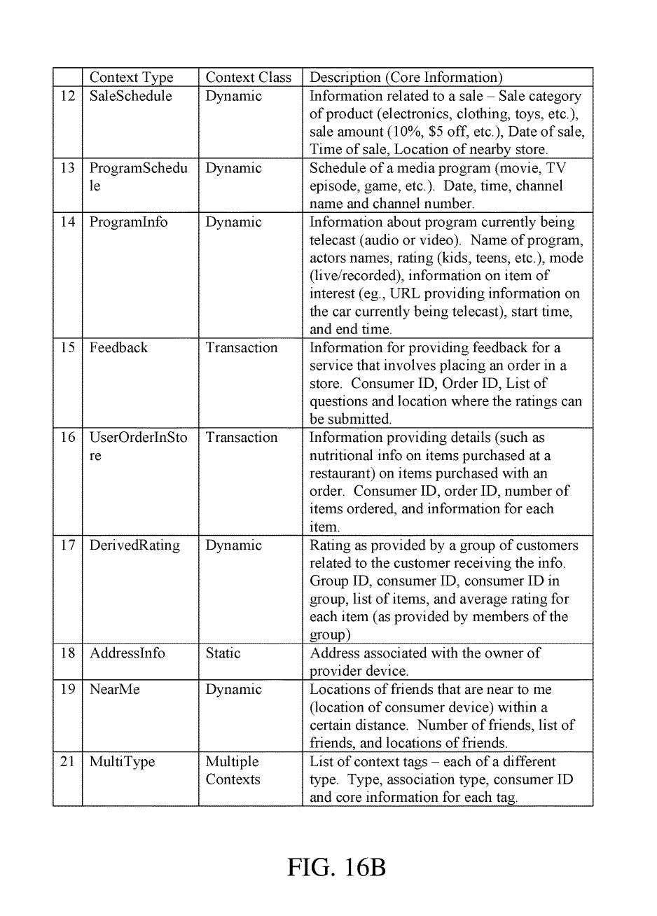

FIG. 16A-B illustrates a list of types, one of which can be associated with a tag according to an embodiment of the present invention. The type associated with tag can be used to differentiate one set of tags from other set of tags, wherein all tags in a set can be associated with same tag type. In some embodiments, the type of the tag can be used to determine the structure and content of information exchanged in the tags. In some embodiments, the type associated with tags can be used to determine the application associated with the tag. The list of types illustrated in FIG. 16A-B is illustrative only. Other embodiments can use types that are not described in FIG. 16A-B. The list of types in FIG. 16A-B are illustrative only and are not meant to limit the scope of the invention or any of its embodiments. Each tag received by a SCD can be associated with a different tag type. In some embodiments, a SCD can associate an application for only some tag types. The set of types that a SCD can associate an application with can vary with each embodiment. The type of a tag can be represented in various forms that can include—an enumeration in “C” programming language, a string in Java programming language, an integer value, the value of an XML TYPE node, or the like.

Moving on, each tagType/ContextType can also be associated with one or more properties referred to as ContextClass(es) or Class(es). The ContextClass of tags illustrated in FIG. 16A-B is indicated in column titled ‘Context Class’. Various Classes of tags are possible, various examples of tags include, but are not limited to, manual tag, static tag, dynamic tag, extracted tag, derived info tag, web based tag, transaction driven tag, and social aspect tags, among others. The class of the tag is determined based on type of content carried in the tag, how the content is determined, and so on. A tagType can also be classified into multiple classes based on the nature of information carried in the tag. It should be appreciated that other classes of tags can also exist in other embodiments.

For example, static class (also referred to herein as the static tag) carries information that does not change over a period of time. Examples of the static tags include, but are not limited to, groceries tag, clothes tag, hospital counter tag and address info tag, from the list of tags illustrated in FIG. 16A-B.

Similarly, a tagType of manual class (also referred to herein as a manual tag) includes information that has been manually provided. An example of such a tag is a dial-an-app tag wherein, the tag includes a phone number dialed by a user of a phone. In some embodiments, the dial-an-app tag is used to determine one or more applications associated with the phone number, and activate corresponding application(s) on the phone used to dial the phone number.

A tagType of dynamic class (also referred to herein as a dynamic tag) includes information that changes over time. Examples of such tags include, but are not limited to, temperature, acceleration, orientation, etc. among the list of tags illustrated in FIG. 16A-B.

A tagType of extracted class (also referred to herein as an extracted tag) includes information that is extracted from media content, or extracted from devices associated with media. Examples of such tags include, but are not limited to, sampleMedia, TvLiveVoting, etc. from the list of tags illustrated in FIG. 16A-B. Some of the extracted tags are also dynamic tags because the information contained in such tags can change.

A tagType of derived info class (also referred to herein as a derived info tag) can include information that is generated based on processing of some information. Examples of such tags include DerivedRating tag as illustrated in FIG. 16A-B. A derived info tag can also be a dynamic tag because the information provided in such tags can change over time.

A tagType of web based class (also referred to herein as a web based tag) can include information that is derived from data on the web (or traversing the internet). Information included can be content filled out by a user in a web form, a URL typed by a user, content from a web page, and so on. Examples of such tag include a WebForm tag as illustrated in FIG. 16A-B. A web based tag can also be dynamic tag because the information provided in such tags can change over time.

A tagType of transaction driven class (also referred to herein as a transaction driven tag) can include information derived from a transaction being performed. Transactions include purchases, bank transactions, electronic payments, electronic reservations, order placements, bookings, etc. A transaction driven tag can also be a dynamic tag because the information provided in such tags can change over time. Example of the transaction driven tags include, but are not limited to, UserOrderinStore and Feedback tags as illustrated in FIG. 16A-B.

A tagType of social aspect class (also referred to herein as a social aspect tag) can include information determined using data from social networks. Examples of such tag include DerivedRating and NearMe tags as illustrated in FIG. 16A-B.

It can be noted that a given tagType can be associated with one or more classes. The set of classes described here is illustrative only, and is not meant to limit the scope of the invention or its embodiments. Other embodiments can have tagTypes that can be associated with classes not described herein.

### Operation of First Embodiment

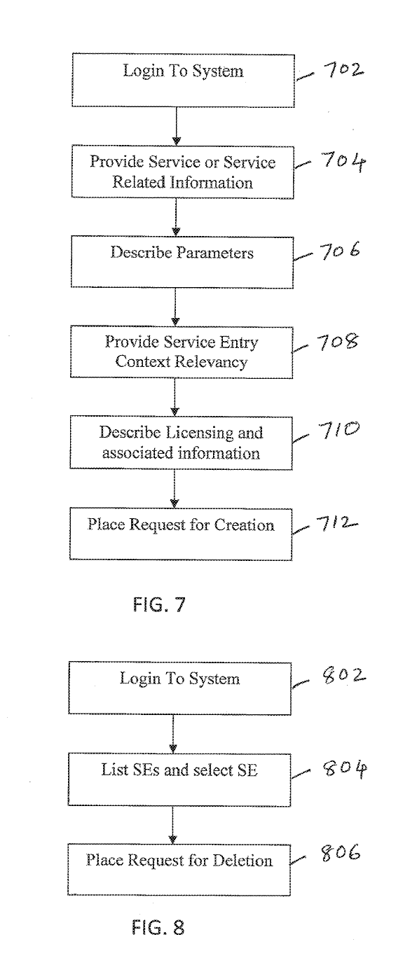

FIG. 7 illustrates the method to be followed in creating an SE in SMS according to an embodiment of the present invention. In an embodiment where a multi-vendor shopping-cart based ecommerce system is used as an aspect/component of SMS, an SE in SMS can be created in a manner similar to how a vendor creates a product in the ecommerce system. In the embodiment described herein, an AD creates SEs in SMS.

The process starts at step 702. At step 702, AD logs-in to SMS, by providing a username and password. New ADs can be added to SMS by having them sign-up for the service. After the user logs in, he/she can select an option to upload/create an SE. The SMS redirects the user to a create-SE page, and moves to step 704.

At step 704, the AD can provide the SVC or information associated with SVC. If a mobile application needs to be provided, it can be uploaded to SMS. The process then moves to step 706.

At step 706, the AD can provide information about any parameters that SVC accepts upon invocation. Information such as number, types of values, the range of values, the structure of information associated with values, a human readable description of values, or the like can be provided. The process then moves to step 708.

At step 708, the AD can provide context relevancy info—SECRI. In some embodiments SECRI can include a phone number. In other embodiments SECRI can include a URL. In yet other embodiments SECRI can include a location/mailing address and/or WiFI information such as SSID/BSSID. In WiFi wireless connectivity, SSID also known as Service Set Identifier identifies a wireless network, and BSSID also known as Basic Service Set Identifier can represent a building block of a wireless 802.11 network. Other information not described here can be provided in other embodiments. After SECRI is provided, the process moves to step 710.

At step 710, an AD can provide licensing information. In an embodiment of the invention, licensing information can include terms of use that specify the amount that an entity needs to be charged under different usage scenarios. For example, and AD can provide prices for different usage patterns, such as fixed amount to be charged per month, another one-time fixed amount, amount based on actual usage, or the like. An AD can also choose to provide the SVC without charging any amount. The amount can be charged to BEs based on the type of license or the charge they select when they place an order. Once licensing option is chosen, the process moves to step 712, wherein a request for creating an order is placed. In some embodiments, an AD can specify the number of times an SVC can be ordered by BEs. This number can be specified while in step 712, or in step 704. In some other embodiments, this is not required. In some other embodiments AD can provide the amount that needs to be charged to an EU when EU purchases the SVC from SMS. The method stops after performing the operation at step 712.

FIG. 8 illustrates the method to be followed in deactivating or removing an SE from SMS according to an embodiment of the present invention. In an embodiment where a multi-vendor shopping-cart based ecommerce system is used as an aspect/component of SMS, an SE in SMS can be removed in a manner similar to how a vendor removes/deactivates a product in the ecommerce system. In the embodiment described herein, an AD deactivates/removes SEs in SMS.

The process starts at step 802. At step 802, AD logs-in to SMS, by providing a username and password. New ADs can be added to SMS by having them sign-up for the service. After the AD logs in, the user selects “Remove SE” at which time, process moves to step 804

At step 804, a list of SEs created by the AD are displayed. After the AD browses the list of SEs, the AD can select an SE at which time the process moves to step 806. While in step 806, the user selects an option to “place request for deletion”. In some embodiments, this request causes the SE to not be accepting any new orders for the SVC removed in this step.

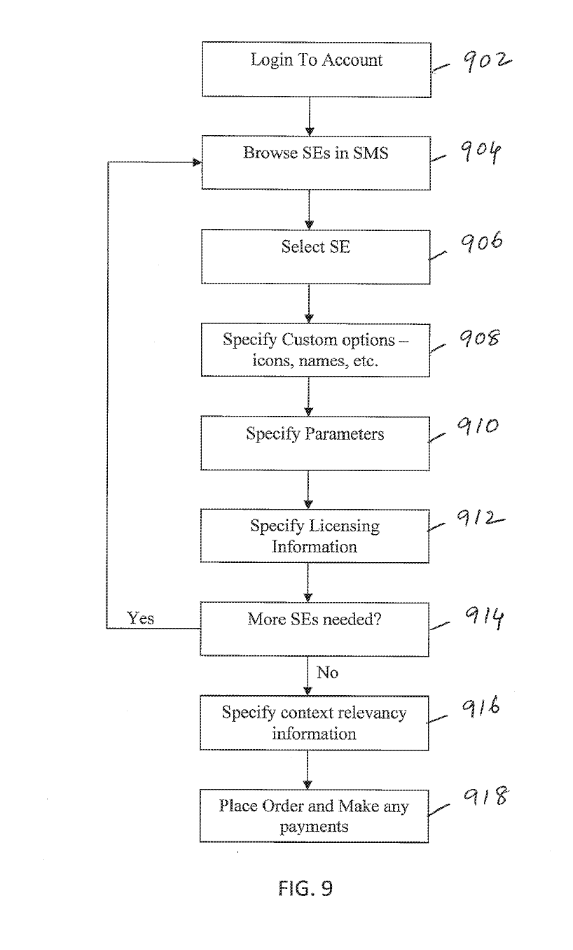

FIG. 9 illustrates the method to be followed in creating an SO in SMS according to an embodiment of the present invention. In some embodiments BEs can create SOs in SMS. In an embodiment where a multi-vendor shopping-cart based ecommerce system is used as an aspect/component of SMS, an SO can be created in a manner similar to how someone places an order for a product on the ecommerce website. BEs can browse the SEs in SMS, add them to an electronic shopping cart, customizing them and selecting licensing information along the way. Once the BEs are done with adding one or more SEs to the cart, they can proceed to create SO. SOs created by BEs can be used to deliver services or applications to customers or end users.

The process begins at step 902. At step 902, BE logs-in to SMS, by providing a username and password. New BEs can be added to SMS by having them sign-up for the service. After the BE logs in, the process moves to step 904.

While in step 904, the BE browses through various SEs in a manner similar to how one would browse items/products on an ecommerce website. At some point of time, the BE likes an SE and decides to add the SE to an electronic shopping cart. This happens in step 906.

When the BE chooses to add an SE to the cart, the BE can be asked to provide any customization options. In one embodiment, the BE can provide a custom name and custom icon that can be used to represent the SVC when presented on the SCD. Once the custom information is provided, the process moves to step 910.

At step 910, the BE is asked to provide values of any parameters that SVC requires, such as the parameters described in step 706 of FIG. 7. If the SVC does not request any parameters, the process moves to step 912.

At step 912, the BE can select one of different licensing terms that were provided by AD when the SE is created. In some embodiments, the licensing term selected by the BE can determine the amount of money that is charged to the BE. The licensing term can also determine if a certain amount of money is charged to BE on a regular basis, or on amount of usage, or the like. The process then moves to step 914.

If the BE chooses to use more SVCs, the BE can proceed to step 904. If not, the process moves to step 916. In step 916, the BE can provide context information wherein the SO can be made relevant and/or available. In some embodiments, the context information can include a phone number such that when someone dials the phone number using an SCD, the SO can be made relevant and available on the SCD. In other embodiments the context information can include a location such that when the SCD is in vicinity of the location, the SO can be made relevant and available on the SCD. Other embodiments can choose to include or use other types of context information, or other methods of matching/comparing context information, not explicitly mentioned here. The SOs are added to SMS and distributed/discovered/managed when the process moves to step 918 and the BE confirms/places the order. While in this step, the SE can make any payments to the SE and/or SMS. The method ends after step 918.

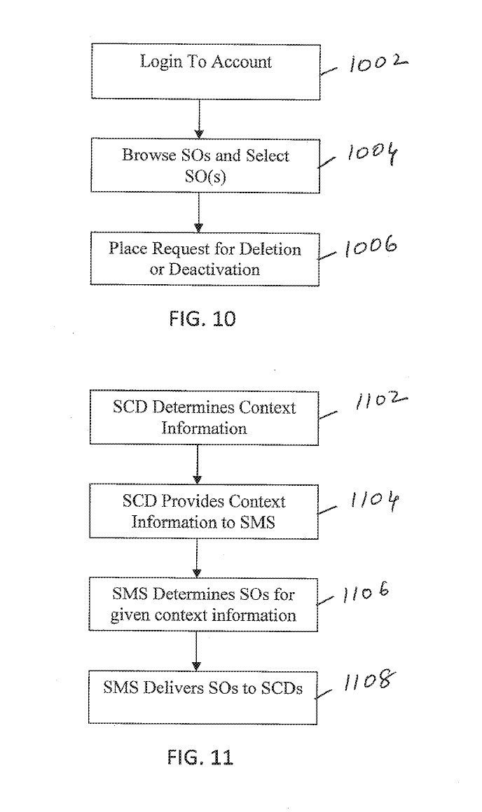

FIG. 10 illustrates a method in removing an SO from SMS according to an embodiment of the present invention. In an embodiment where a multi-vendor shopping-cart based ecommerce system is used as an aspect/component of SMS, an SO in SMS can be removed in a manner similar to how a customer cancels an order in the ecommerce system. In the embodiment described herein, a BE deactivates/removes SOs in SMS.

The process starts at step 1002. At step 1002, BE logs-in to SMS, by providing a username and password. New BEs can be added to SMS by having them sign-up for the service. After the BE logs in, the user selects “Remove SO” at which time, process moves to step 1004, where the list of SOs created by the BE are displayed. After the BE browses the list of SOs, the BE can select an SO at which time the process moves to step 1006.

While in step 1006, the user selects an option to “place request for deletion”. Once the SO is deleted/removed, the SO may no longer be made available, managed or discovered. In some embodiments wherein the information associated with active SOs is maintained across a large array of systems, deleting an SO may take time for the SO to be made irrelevant and not discovered/available. The amount of time in such systems is dependent on the actual embodiment.

FIG. 11 illustrates a method of discovering and delivering services, according to an embodiment of the present invention. In an embodiment of the present invention, SCDs continuously monitor their environment (including state of applications, sensors associated with SCD, etc.) to determine tags. The set of entities that the SCD monitors, and method of determining tags can be specific to each embodiment. In one embodiment, SCD can be monitoring the phone numbers dialed by the user. In yet another embodiment, SCD can be monitoring the URLs visited by the user on the SCD. In other embodiments, the SCD can be monitoring WiFi environment to determine the SSID/BSSID based tags. In yet other embodiments, the SCD can be monitoring more than one type of sensor/service. In other embodiments, SCD 102 can be an instance of CD as described and operating as in patent application Ser. No. 13/193,380.

The process begins at step 1102. SCD determines context info at this step. The process then moves to step 1104. At step 1104, SCD provides the context info to SMS. The context information can be relayed to APPSELECTOR 202 of SMS 200, and the process moves to step 1106.

APPSELECTOR 202 looks up DATABASES 276 on disk 265. DATABASES 276 on disk 265, is populated by Application 267 when SEs and SOs are created in SMS. APPSELECTOR 202 compares received context with SECRI and/or SOCRI stored along with SEs and SOs in DATABASES. The lookup is used to determine SEs and/or SOs relevant to the context information received by the SMS. Once the set of relevant SEs and/or SOs are determined, the process moves to step 1108.

At step 1108, relevant SEs and/or SOs are delivered and made available on the SCD. This method is repeated for each context information received by the SMS, each from the same or different instances of SCD 102. The method described here is applicable to an embodiment of the invention. Other embodiments can choose to represent SMS using an array of co-ordinated computer systems and/or distributed database systems to allow for supporting an increased number of SEs, SOs, number/rate of context messages, number of SCDs or the like. In yet other embodiments the method of determining relevant SEs or SOs for context information received from SCDs may not compare the context information against SECRI and/or SOCRI. In yet other embodiments, recommendation systems, information retrieved from description of the SVC, comments provided by users of SMS, information regarding SVC on the internet, or the like can be used to determine relevancy and/or discovery. Other methods of discovering and delivering applications and/or services are possible in other embodiments.

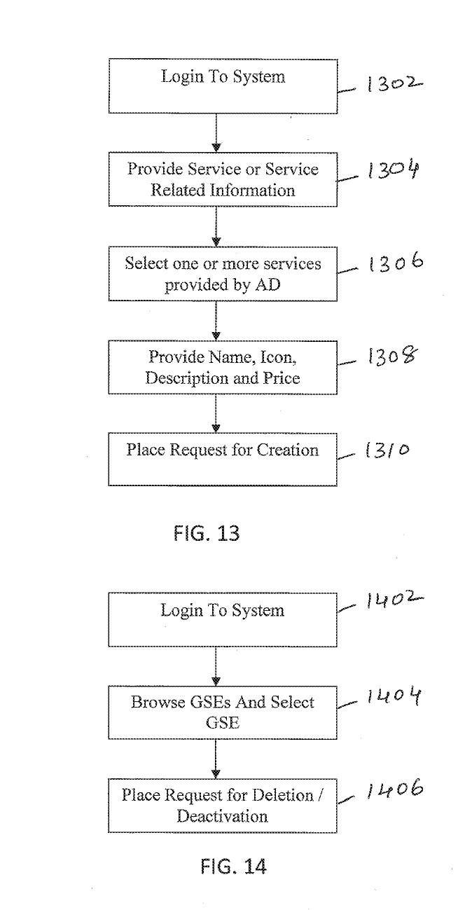

FIG. 13 illustrates a method of creating a group service entry, representing a set of applications or services, according to an embodiment of the present invention. A group service entry (GSE) can be used to represent one or more services, bundled together as a single service entry in SMS. In an embodiment where a multi-vendor shopping-cart based ecommerce system is used as an aspect/component of SMS, a GSE can be represented using a bundled product, which represents a group or set of products. A customer placing an order for a bundled product is provided with the set or group of products associated with the bundled product. A GSE can be used to represent a set of applications and/or services such that an end user (EU) can purchase GSE (the set of applications and/or services in GSE) for indefinite use, in a manner similar to purchasing an app on app stores such as Android Market, Amazon App Store, or the like. An EU can also order GSE for a limited-time use, such that the applications and/or services in GSE won't be available for use by EU (on SCD) after the expiry of limited-time period.

In the embodiment described herein, a GSE can be created by AD. The process starts at step 1302. At step 1302, AD logs-in to SMS, by providing a username and password. New ADs can be added to SMS by having them sign-up for the service. After the user logs in, he/she can select an option to upload/create an SE. The SMS redirects the user to a create-SE page, and moves to step 1304.

At step 1304, the AD can optionally provide SVC or information associated with SVC to SMS. The process then moves to step 1306. At step 1306, the AD can select one or more of the SVCs provided by the AD, in preparation of creating the GSE. The process then moves to step 1308.

At step 1308, the AD provides a name, icon, description and price associated with GSE. The AD can also provide information about whether the GSE can be purchased by EU for indefinite use, or for limited duration—such as a month. Once this is complete, the process moves to step 1310.

At step 1310, AD places request for creating the GSE, and the process terminates. In some embodiments, the process of creating GSE, can involve creating copies of SVC associated with GSE such that GSE has its own copy of SVC. This can be done to ensure that if an SE associated with the SVC (referred to by GSE) is removed, the GSE can continue to function.

It can be noted that the process described here, the information associated with GSE, and other aspects are exemplary, and are associated with this embodiment. Other embodiments can represent bundled apps in a different way and/or associate different set of information with the bundled product.

FIG. 14 illustrates a method of removing or deactivating a group service entry (GSE), representing a set of applications or services, according to an embodiment of the present invention. In an embodiment where a multi-vendor shopping-cart based ecommerce system is used as an aspect/component of SMS, a GSE in SMS can be removed in a manner similar to how a vendor removes/deactivates a bundled product in the ecommerce system. In the embodiment described herein, an AD deactivates/removes GSEs in SMS.

The process starts at step 1402. At step 1402, AD logs-in to SMS, by providing a username and password. New ADs can be added to SMS by having them sign-up for the service. After the AD logs in, the user selects “Remove GSE” at which time, process moves to step 1404, where the list of GSEs created by the AD are displayed. After the AD browses the list of GSEs, the AD can select a GSE at which time the process moves to step 1406.

While in step 1406, the user selects an option to “place request for deletion”. In some embodiments, this request causes the GSE to not be accepting any new orders as described in FIG. 13. In some embodiments, when the GSE is associated with time-based purchases, orders active in SMS and associated with the GSE being removed, can be deactivated by SMS before the GSE is completely deactivated/removed. In yet other embodiments, time-based GSEs upon request for deactivation, do not accept new orders. These GSEs are completely deactivated when existing active orders (time based) are no longer active. Orders placed by EU for time-based GSE purchases, are not active when the time period associated with the order has passed, or when the EU decides to cancel that order. It can be noted that the method of deactivating GSE described here is exemplary, and associated with the specific embodiment described here. Other embodiments can have other behaviors or methods of deactivating GSEs.

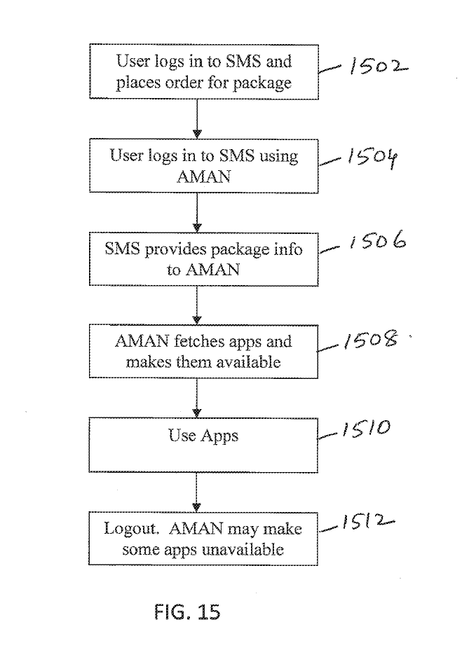

FIG. 15 illustrates a method of accessing group service entries on an SCD, according to an embodiment of the present invention. In and embodiment of current invention described here, applications and/or services represented by GSEs can be accessed using SCD 102, in co-ordination with AMAN 112. EU can place orders for GSEs that are either indefinite or time-based, in SMS. The method can be similar to how end users place orders for apps in app-stores. When a EU places order for a GSE in SMS, AMAN 112 in co-ordination with SMS determines the GSEs ordered by EU associated with SCD 102. AMAN 112 can determine the EU for which GSE related apps can be retrieved from SMS, when EU logs in to SMS using AMAN 112.

The method starts at step 1502 wherein user logs-in to SMS and places order for GSE, either using AMAN 112, or any means by which orders can be placed in SMS. In some embodiments EU can login to SMS and place orders by using a computer system. The process moves to step 1504.

At step 1504, EU logs-in to SMS using AMAN 112. If the EU is already logged in to SMS using AMAN 112 of SCD 102, this step is not required. The process then moves to step 1506.

At step 1506, AMAN 112 contacts SMS to determine GSEs ordered by EU. In an embodiment of the invention, SMS communicates GSEs ordered by EU to AMAN 112 when the order is placed. The process then moves to step 1508.

At step 1508, AMAN 112 in communication with SMS makes the apps associated with GSEs ordered by EU, available on SCD 102. For GSE purchases that are for indefinite use, AMAN 112 can initiate installation of applications and/or services represented by the purchased GSE, to allow for indefinite use by EU on SCD. Such applications can be removed by explicit request for uninstalling, by EU. On the other hand, for GSE purchases that are time-based, AMAN 112 can make the applications/services of GSE available for use by EU such that they can be made unavailable, under the control of AMAN 112.

Availability of an application can be indicated to the EU of SCD, by displaying an icon and text on the display of SCD. When EU initiates the launch of application, say by clicking the displayed icon, AMAN can fetch associated application and launch it for execution. The fetched application can include one or more of web-services, web content, java script, java byte code, CPU executable code, or the like. The fetched application can also include applications that can be installed by user on the SDC, a modified version of such installable applications, or the like. The application can be executed or run directly by hardware and/or components of SCD, or by means of other software that can be running on SCD.

Applications can also be executed on a system outside SCD such that user interactions can be relayed between SCD and the executing application. The relaying can be done by AMAN or other software and/or firmware and/or hardware components of SCD. Application can include any combination of software and/or firmware and/or hardware that can provide some services to SCD and/or EU. The process then moves to step 1510.

While in step 1510, the EU can use the apps made available in earlier steps. When the EU is logged out of SMS by AMAN 112—by an explicit action such as selecting a “Logout” option on AMAN 112, or by implicit means such as expiry of an idle timeout, the process moves to step 1512 where AMAN 112 can make applications and/or services of limited-time GSEs unavailable. The process terminates at this step. If the EU chooses to login to SMS via AMAN 112, at a later time, AMAN 112 can fetch existing time-based GSEs and make applications/services of GSE available for use on SCD 102.

It can be noted that the process described here is representative of an embodiment described here. Other methods of accessing or managing GSEs are possible.

### System of First Embodiment

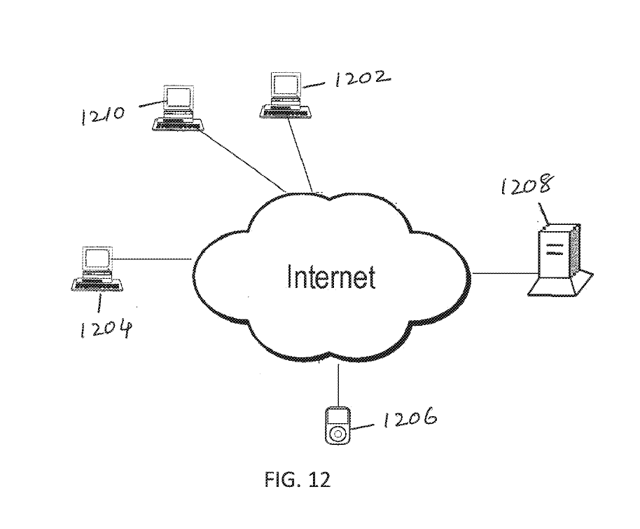

FIG. 12 illustrates a system of creating services, managing and delivering them according to an embodiment of the present invention. The embodiment described herein consists of a computer 1202, a computer 1204, a mobile device 1206 representing an SCD, a computer 1210, and a server computer system 1208 representing an SMS. These aspects can communicate with each other over a communication network such as the internet, or the like. Computer 1202 is used by an AD to create SEs in SMS 1208. Computer 1204 is used by BEs to create SOs in SMS 1208. Computer 1210 can be used by end users (EU) to login to SMS and purchase application and/or services and/or GSEs, or other operations. SCD 1206 can provide context information to SMS to determine/fetch relevant apps. The system described in FIG. 12 is illustrative, used by an embodiment. Other embodiments can have different aspects. There can be more than one instance of computer systems 1202 and/or 1204 used for creating SEs and/or SOs. A given computer system can also be used to create SE and/or SO, based on whether the user currently logged-in is a AD or BE respectively. SMS 1208 can be represented using an array of computer systems to support a large number of SEs and/or SOs and/or large number of SCDs 1206. In yet other embodiments, aspects of SMS relating to creating and managing SEs and/or SOs can be separated out from aspects relating to determining and delivering relevant apps to SCD 1206. Similarly aspects associated with determining relevancy can also be separated out. When such separation is done, these separate entities of SMS can co-ordinate with each other. SMS can also be associated with other services and/or features not described herein. It should be noted that the structure, operation and systems are not meant to limit the scope of the invention or any of its embodiments.

Embodiments of the present invention can be applied to a wide variety and/or combination of entities, allowing for sharing, discovering, managing and delivering services. Entities involved in the system may benefit directly, due to business transactions. Entities may also benefit indirectly, and the benefits may not be associated with the aspects/systems described here. Although the invention has been described with reference to specific embodiments, entities, their interactions, role and aspects, it will be appreciated that the invention is meant to cover all modifications and their equivalents.

Embodiments of the present invention can be applied to a wide variety of services that can include services related to provisioning/consumption of media such as audio, video, etc. as in case of watching video, listening to audio, etc.; browsing of web; services at grocery stores, restaurants, malls, theatres, other stores, etc.; services at places such as parking lots, ticket counters, etc.; transaction services such as borrowing of books in a library, purchase of products, etc.; or the like. Embodiments of the invention can be used in association with systems and/or services different from the above listed set of systems and/or services.

Embodiments of the present invention can be realized using any combination of dedicated components and/or programmable processors and/or other programmable devices. While the embodiments described above may make reference to specific hardware and software components, those skilled in the art will appreciate that different combinations of hardware and/or firmware and/or software components may also be used and that particular operations described as being implemented in hardware might also be implemented in software and/or firmware and vice versa. Functions described as being implemented in firmware can be implemented in hardware and/or software and vice versa. Similarly functions described as being implemented in software can be implemented in hardware and/or firmware and vice versa.

Computer programs incorporating various features of embodiments of the present invention may be encoded on various computer readable storage media, suitable media include magnetic disk or tape, optical storage media such as compact disk or DVD (digital versatile disk), flash memory, and the like. Computer readable media encoded with the program code may be packaged with a compatible device or provided separately from other devices Program code may also be encoded and transmitted using carrier signals (e.g., via Internet download) adapted for transmission via wired, optical, and/or wireless networks conforming to a variety of protocols, including the Internet.

Thus, although the invention has been described with respect to specific embodiments, it will be appreciated that the invention is intended to cover all modifications and equivalents.

1. An application management system for managing distribution or access of at least a one or more applications, the system comprising:
a. one or more application management servers configured with at least one or more input modules, wherein:
at least one of said one or more input modules are configured to at least receive at least a portion of said one or more applications, or at least a portion of a first one or more application identification information, wherein at least a portion of said first one or more application identification information can be used to at least one of identify and determine said one or more applications;
at least one of said one or more input modules are configured to at least receive a first context relevancy information, said first context relevancy information comprising a first context value, at least a portion of said first context value can be at least one of determined, associated with and compared against information determined based on at least a portion of at least one of:
a value generated by a sensor associated with a service consumption device;
a message received on a communication interface associated with a service consumption device;
information extracted or determined from at least one of audio content, visual content and audio-visual content;
information extracted or determined from web content;
information associated with a commercial transaction; and
a phone number;
b. one or more application management servers configured with at least a storage repository, said storage repository configured to at least store at least a portion of one or more of:
said one or more applications;
said first one or more application identification information; and
said first context relevancy information;
c. one or more application management servers configured with at least a receiving module, said receiving module configured to at least receive a first contextual tag, wherein said first contextual tag comprises information determined from at least one of an environment and activity of at least one or more of:
a first service consumption device of a user; and
a first user associated with said first service consumption device;
and;
d. a first one or more application management servers, said first one or more application management servers communicatively associated with at least one or more of said storage repository and said receiving module, said first one or more application management servers configured to at least:
i. comparing at least a portion of said first contextual tag with at least a portion of said first context relevancy information; and
ii. determine at least a portion of one or more of:
said one or more applications; and
said first one or more application identification information.

2. The application management system of claim 1, wherein said one or more applications comprises one or more SVC.

3. The application management system of claim 2, said application management system further comprising one or more application management servers configured to at least enable delivery to at least one service consumption device, at least a portion of one or more of:
said one or more applications; and
said first one or more application identification information.

4. The application management system of claim 3, said application management system further comprising one or more application management servers configured to at least enable delivery of at least a portion of one or more of:
a. a third plurality of information, wherein at least a portion of said third plurality of information is consumed by at least one of said one or more applications;
b. a custom name;
c. a custom icon; and
d. other information.

5. The application management system of claim 3, wherein enabling said delivery further enables execution of at least one instruction associated with at least one of said one or more applications, on a service consumption device.

6. The application management system of claim 2, wherein at least one of said one or more input modules, are further configured to at least accept information from at least one of an app developer, a business organization, an end user, a non-profit organization, an educational institution, a user and an entity.

7. The application management system of claim 2, wherein execution of at least one instruction associated with at least one of said one or more applications enables at least a portion of one or more financial transactions.

8. The application management system of claim 2, wherein at least one of said one or more input modules are further configured to at least enable a first one or more financial transactions.

9. The application management system of claim 2, wherein at least one of said one or more input modules are further configured to at least accept information due to a user interaction event.

10. The application management system of claim 2, wherein said one or more applications further comprises at least a portion of one or more of a web service and a web application.

11. The application management system of claim 8, wherein said first one or more financial transactions comprises a second one or more financial transactions and a third one or more financial transactions, said second one or more financial transactions are scheduled to execute at a time after a time at which said third one or more financial transactions are executed.

12. The application management system of claim 2, wherein said first contextual tag comprises at least a portion of one or more of a phone number, a location, a media content, a web link, a URL, a static tag, a dynamic tag, a manual tag, an extracted tag, a derived info tag, a web based tag, a transaction driven tag, a social aspect tag, a date and time tag, a time duration tag, and a dial-an-app tag.
